(19) United States
(12) Patent Application Publication
(10) Pub. No.: US 2004/0202215 A1
(43) Pub. Date: Oct. 14, 2004

(54) Programmable damping for laser drivers

(75) Inventor: Alexander Fairgrieve, Menlo Park, CA (US)

Correspondence Address: FLIESLER MEYER, LLP, FOUR EMBARCADERO CENTER, SUITE 400, SAN FRANCISCO, CA, 94111, US

(73) Assignee: Elantec Semiconductor, Inc., Milpitas, CA (US)

(21) Appl. No.: 10/771,197

(22) Filed: Feb. 3, 2004

Related U.S. Application Data
(60) Provisional application No. 60/461,454, filed on Apr. 9, 2003.

(51) Int. Cl. H01S 3/00

(52) U.S. Cl. 372/38.02

(57) ABSTRACT

A laser driver includes a programmable damping resistor that provides an adjustable damping resistance to improve a laser light output response. The laser driver can also includes a controller that is adapted to adjust the programmable damping resistor based on an input signal. Such an input signal can, for example, specify characteristics of a driven load, components that make up the load, or the like. The controller can then determine and select a desirable damping resistance based on the provided input.

### PRIORITY CLAIM

This application claims priority under 35 U.S.C. 119(e) to U.S. Provisional Patent Application No. 60/461,454, filed Apr. 9, 2003, entitled “PROGRAMMABLE DAMPING FOR LASER DRIVERS,” which is incorporated herein by reference.

### FIELD OF THE INVENTION

The present invention relates to laser drivers, and more particularly to the damping of laser driver outputs.

### BACKGROUND OF THE INVENTION

In the field of optical data storage, a current is driven through a laser diode to cause it to emit light. This beam of light is then focused onto the surface of an optical disc for the purpose of reading or writing data. When writing data, the current through the laser diode has to be rapidly changed as the optical drive writes the digital “ones” and “zeroes”. Different formats of optical drives require different waveforms, but all have the common goal that when current switches, it would be ideal if the laser light output could change instantaneously from the old light level to the new level as shown in FIG. 1.

The behavior of real components interferes with this goal and results in the output current having to face various resistive (R), inductive (L), and capacitive (C) components that result in a distorted waveform. In a typical system, a laser driver has an output structure that can be simplified as a large capacitance with a shunt resistor. This is soldered onto a small pc board or flex cable, where it drives a laser diode. As shown in FIG. 2, a laser driver 202 can be modeled as a current source (I) and a R/C network including a capacitor C1 and a resistor R1; a laser diode 206 can be modeled as an L/C/R network including a capacitor C2, a resistor R2, and an inductor L3; and a pc board 204 (and/or flex cable) can be modeled as an L network including inductors L1 and L2. More sophisticated models can of course be applied, but this basic modeling is sufficient to demonstrate the problem to be solved.

The result of this network is that when a change of current is output from the laser driver 202, the network has a ringing response, since the use of the components (e.g., transistors) in this type of an application always result in resistance values that cause an under damped LC response. Thus, the pulse output overshoots and undershoots before ultimately settling, as shown in FIG. 3. This overshoot and undershoot is highly undesirable in such an application, for a variety of reasons. Better drive performance, as ultimately seen by BER (bit error rate) is obtained by attenuating this overshoot and undershoot to a small, but acceptable level.

For a given set of components, it is possible to add external damping networks that sufficiently reduce the overshoot and undershoot to an acceptable level, but it is also possible to modify the laser driver or the pc board layout to achieve similar results. Generally, little can be done to modify the laser diode characteristics. However, the nature of this application is cost driven, and optical data storage suppliers are reluctant to improve the waveform by raising the pc board cost, or by adding external damping components, if they can get the laser driver manufacturer to make some design adjustments for “free”.

The problem for the laser driver manufacturer is that whatever adjustment is made, it is only optimized for a given pc board and laser diode. If the customer then changes the pc board design and/or substitutes a laser diode from another vendor, the laser driver optimization is no longer optimized, and the laser pulse response may now be unacceptable again. Accordingly, there is a need to overcome the above discussed problems and disadvantages.

### SUMMARY OF PRESENT INVENTION

Embodiments of the present invention relate to a laser driver adapted to drive a load including a laser diode. The laser driver is made up of components, such as transistors, that produce an undesired parasitic capacitance. A programmable damping resistor, within the laser driver, is in parallel or in series with the parasitic capacitance. This programmable damping resistor enables one of a plurality of different damping resistances to be selected to improve a laser light output response.

For further optimization, a damping capacitor can also be included in the laser driver (i.e., in combination with the programmable damping resistor).

In accordance with embodiments of the present invention, the laser driver also includes a controller that is adapted to adjust the programmable damping resistor based on an input signal. Such an input signal can, for example, specify the inductive, capacitive and resistive characteristics of the load. Then the controller can determine a desirable damping resistance based on the specified characteristics. Alternatively, the input signal can identify the components making up the load (e.g., the pc board and the laser diode), and the digital controller can determine a desirable damping resistance based on the identified components. In other embodiments, the input signal specifies the desired damping resistance. In still other embodiments, the controller can dynamically adjust the programmable damping resistor based on a dynamic input. For example, the dynamic input can relate to a drive current that drives the laser diode. Alternatively or additionally, the dynamic input can relate to a temperature of the laser driver. Alternatively or additionally, the dynamic input can relates to a voltage supply used to power the laser driver.

Further embodiments, and the features, aspects, and advantages of the present invention will become more apparent from the detailed description set forth below, the drawings and the claims.

### BRIEF DESCRIPTION OF THE FIGURES

FIG. 1 shows an ideal laser light output waveform.

FIG. 2 shows an exemplary model of a system including a laser driver, a pc board and a laser diode.

FIG. 3 shows a ringing laser light output waveform.

FIG. 4 shows a fixed damping resistor and fixed damping capacitor within a laser driver.

FIG. 5 shows a shunt programmable damping resistor within a laser driver, in accordance with embodiments of the present invention.

FIG. 6 shows a programmable damping resistor within a laser driver, in accordance with embodiments of the present invention, where the programmable damping resistor is placed in series with the parasitic capacitance of the laser driver.

FIG. 7 shows an exemplary embodiment of a programmable damping resistor.

FIG. 8 shows an exemplary embodiment of a programmable damping resistor and a programmable damping capacitor.

FIG. 9 shows an exemplary embodiment of a programmable damping resistor and capacitor.

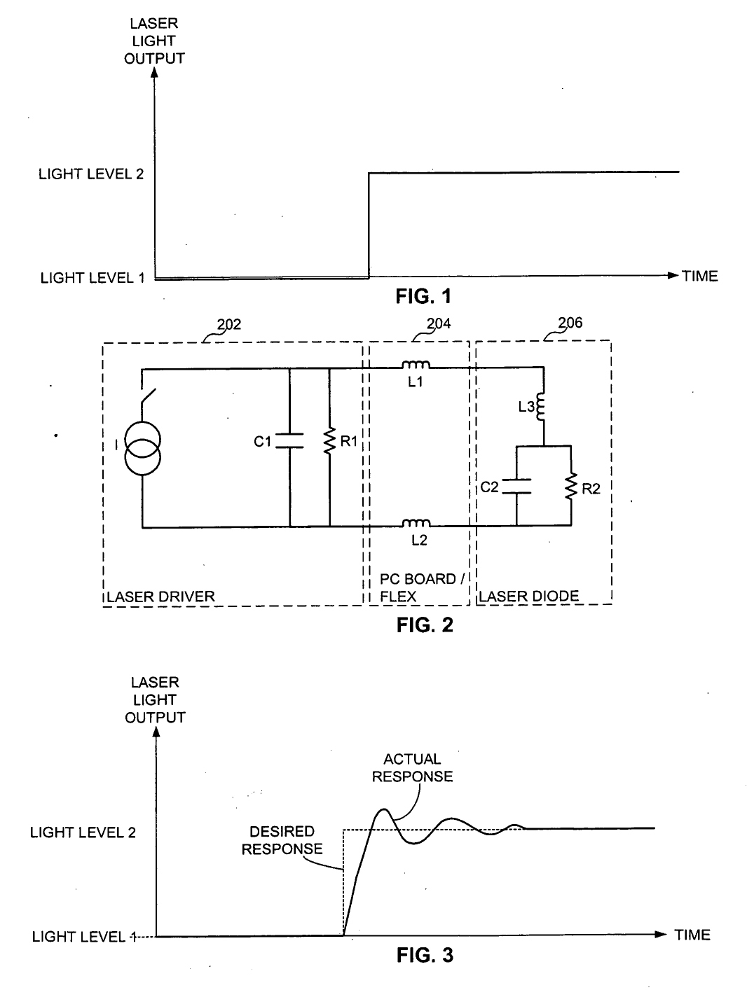

### DETAILED DESCRIPTION

As mentioned above, for a given set of components, it is possible to add external damping networks that sufficiently reduce the overshoot of a light output signal to an acceptable level. The problem for the laser driver manufacturer is that whatever adjustment is made, it is only optimized for a given pc board and laser diode. If the customer then changes the pc board design and/or substitutes a laser diode from another vendor, the laser driver optimization is no longer optimized, and the laser pulse response may now be unacceptable again. It is in this context that embodiments of the present invention employ programmable pulse damping, to thereby eliminate the need to modify the laser driver design for every different pc board and laser diode combination. Benefits of embodiments of the present invention include reduced time to achieve waveform optimization and reduced costs for both customers and vendors.

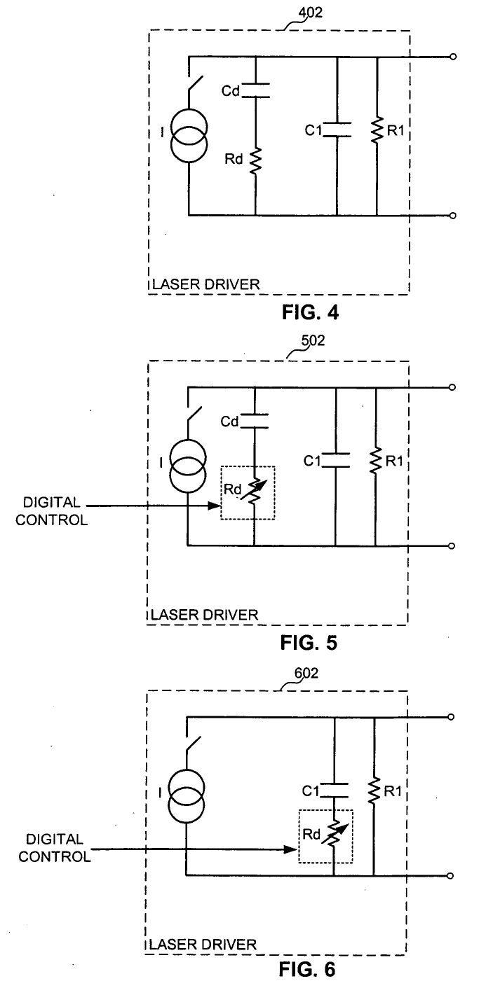

The assumption is made that for whatever reason, the drive manufacturer is committed to a given pc board layout, laser diode, and other components, and that all further waveform improvement must be achieved in the laser driver design. It is possible to improve damping with a fixed series resistance, a fixed shunt resistance, and other fixed methods, but they would all remain fixed for a given laser driver design. For example, if the output of a laser driver 402 were to have a fixed damping resistor Rd and fixed damping capacitor Cd inserted in the correct location to improve the damping of the response, as shown in FIG. 4, it would still be necessary to change this resistor Rd for each and every application In accordance with embodiments of the present invention, a programmable solution is provided, thereby allowing a laser driver to be used in many applications without the need for redesigning the laser driver.

Embodiments of the present invention provide for the programming of an optimal resistor value, from a range of resistor values, to provide better damping of a current pulse into an LC dominated load.

First embodiments of the present invention are now described with reference to FIG. 5. As shown in FIG. 5, rather than having a fixed damping resistor Rd, a programmable resistor Rd is built into a laser driver 502. The programmable resistor Rd is shown as being a shunt resistor in FIG. 5 that is in parallel with the parasitic capacitance C1 and inherent resistance R1 of the laser driver 502. FIG. 5 also shows a damping capacitor Cd that is in series with the programmable resistor Rd. The damping capacitor Cd can be a fixed capacitor, or alternatively, can also be programmable to provide for further optimization.

Second embodiments of the present invention are now described with reference to FIG. 6. As shown in FIG. 6, a programmable resistor Rd is built into a laser driver 602 such that it is in series with the parasitic capacitance C1 of the laser driver 602. In this embodiment, there is no need for a further damping capacitor Cd, however, one can be added if desired for possible further optimization.

The programmable resistor Rd (in FIGS. 5 and 6) is shown as receiving a digital control signal that is used to specify (i.e., set) the resistance of the resistor Rd. The resistance of the programmable resistor Rd (and optionally also a capacitance of a programmable capacitor Cd) is appropriately selected to dampen the output of the laser driver, to thereby provide an optimal (or near optimal) laser light output response.

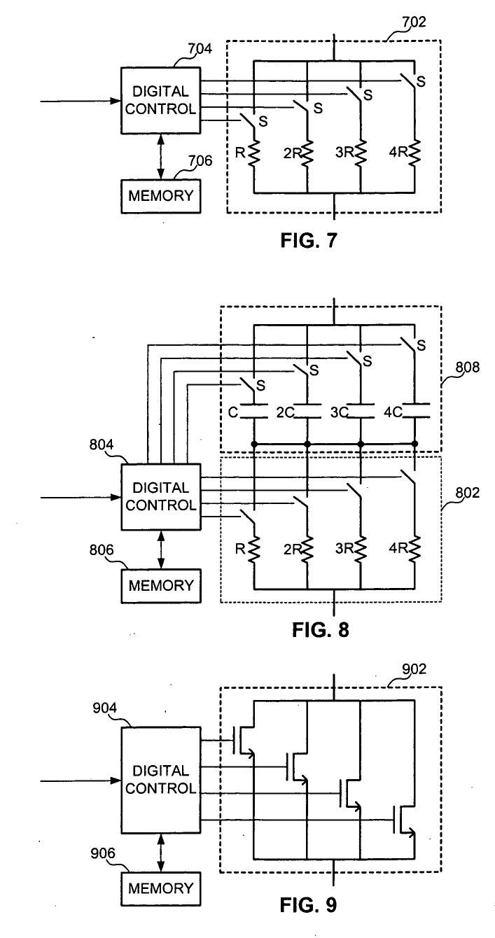

The programmable resistor Rd can include a resistor bank 702, as shown in FIG. 7. The resistor bank 702 can include a plurality of selectable resistors in parallel. For example, each resistor includes a respective switch S (e.g., a switching transistor), as shown in FIG. 7. Each resistor can have the same resistance, or more likely, each resistor is differently weighted to provide for a wider range of possible resistances. The resistors can be weighted in a progressive fashion (e.g., R, 2R, 3R, 4R), a binary fashion (e.g., R, 2R, 4R, 8R), or in any other arrangement. The use of four resistors is only an example. More or less resistors can be included in the resistor bank 702.

In accordance with an embodiment of the present invention, a digital controller 704 (within the laser driver) receives a digital control signal that specifies which resistor(s) (e.g., within the resistor bank 702) are to be selected (e.g., which switches are to be closed). Alternatively, a digital control signal specifies a desired resistance, and then the digital controller 704 determines and selects the appropriate resistors to achieve the desired resistance (or the closest to the desired resistance as possible). In another embodiment, a digital control signal specifies the characteristics (e.g., inductive, capacitive and resistive characteristics) of the pc board/flex cable and the laser diode. Then the digital controller 704 uses an appropriate algorithm(s) and/or lookup table(s) (e.g., stored in an accessible memory 706, preferably within the laser driver) to determine the appropriate resistance that should be programmed. In a silicon based solution, a weighted resistor DAC (similar to resistor bank 702) is one of several schemes that can be used to provide the programmable resistor.

In each of these embodiments, the digital controller 704 can control the programmable resistor (e.g., resistor bank 702). For example, the digital controller 704 closes the appropriate switches S in the resistor bank 702 to achieve the desired resistance.

As mentioned above, a programmable damping capacitor Cd can also be included in the laser driver, to further optimize the laser light output response. As shown in FIG. 8, the programmable damping capacitor Cd can be, for example, a capacitor bank 808 in series with the programmable damping resistor Rd (e.g., resistor bank 802). A digital controller 804 can determine and select the appropriate damping capacitance in a similar manner as it can determine and select the appropriate damping resistance, as explained above.

In accordance with an embodiment of the present invention, the programmable resistor Rd includes a bank of transistors 902 (e.g., CMOS transistors), as shown in FIG. 9. A digital controller 904 can determine the appropriate damping resistance Rd (and, optionally, damping capacitance Cd), as discussed above, and then apply appropriate gate or base currents to achieve the desired damping. Alternatively, or additionally, the transistor bank 902 can include transistors of different sizes that can be used to achieve a broad range of resistances and capacitances.

The above described embodiments describe exemplary programmable damping resistors Rd and damping capacitors Cd. One of ordinary skill in the art will appreciate that other types of programmable resistors and capacitors, within a laser driver, are within the spirit and scope of the present invention.

The damping resistance provided by the programmable resistor Rd need not be static for a given pc board/flex cable and laser diode combination. For example, the digital controller (704, 804, 904) can receive additional inputs that can be used to better optimize the laser light output response. Referring back to FIGS. 4-6, the parasitic capacitance C1 of the laser driver is not a fixed value. Rather, the parasitic capacitance C1 actually changes as the drive current produced by the current source I (e.g., a write DAC or write current amplifier, or read DAC or read current amplifier) changes, as the temperature of the laser driver changes (e.g., the laser driver can be hot or cold). The parasitic capacitance C1 can also be effected by the voltage supply (Vsupply) used to power the laser driver. Accordingly, in accordance with embodiments of the present invention, the digital controller dynamically adjusts the damping resistance Rd (and optionally, also the damping capacitance Cd) in order to continually optimize the laser light output response. For example, the digital controller (704, 804, 904) can use algorithm(s) and/or lookup table(s) to determine what damping resistance Rd should be programmed for certain operating conditions (e.g., write strategy and/or temperature) and for specific components (e.g., pc board or flex cable and laser diode).

The forgoing description is of the preferred embodiments of the present invention. These embodiments have been provided for the purposes of illustration and description, but are not intended to be exhaustive or to limit the invention to the precise forms disclosed. Many modifications and variations will be apparent to a practitioner skilled in the art. Embodiments were chosen and described in order to best describe the principles of the invention and its practical application, thereby enabling others skilled in the art to understand the invention. It is intended that the scope of the invention be defined by the following claims and their equivalents.

What is claimed is:

1. A laser driver adapted to drive a load including a laser diode, the laser driver comprising:
components that result in a parasitic capacitance; and
a programmable damping resistor adapted to selectively provide a plurality of different damping resistances;
wherein one of the plurality of different damping resistances can be selected to improve a laser light output response.

2. The laser driver of claim 1, wherein the programmable damping resistor is in parallel with the parasitic capacitance.

3. The laser driver of claim 1, wherein the programmable damping resistor is in series with the parasitic capacitance.

4. The laser driver of claim 1, wherein the programmable damping resistor includes a plurality of selectable resistors.

5. The laser driver of claim 1, wherein the programmable damping resistor includes a plurality of controllable transistors.

6. The laser driver of claim 1, further comprising a controller adapted to adjust the programmable damping resistor based on an input signal.

7. The laser driver of claim 6, wherein the input signal specifies the inductive, capacitive and resistive characteristics of the load, and wherein the digital controller determines a desirable damping resistance based on the specified characteristics.

8. The laser driver of claim 6, wherein the input signal identifies components making up the load, and wherein the digital controller determines a desirable damping resistance based on the identified components.

9. The laser driver of claim 6, wherein the input signal specifies a desired damping resistance.

10. The laser driver of claim 1, further comprising a controller adapted to dynamically adjust the programmable damping resistor based on a dynamic input.

11. The laser driver of claim 10, wherein the dynamic input relates to a drive current that drives the laser diode.

12. The laser driver of claim 10, wherein the dynamic input relates to a temperature of the laser driver.

13. The laser driver of claim 10, wherein the dynamic input relates to a voltage supply used to power the laser driver.

14. The laser driver of claim 1, further comprising a fixed damping capacitor in series with the programmable damping resistor.

15. The laser driver of claim 1, further comprising a programmable damping capacitor in series with the programmable damping resistor.

16. A laser driver adapted to drive a load including a laser diode, the laser driver comprising a programmable damping resistor adapted to improve a laser light output response, wherein the programmable damping resistor is in series with a parasitic capacitance of the laser driver.

17. The laser driver of claim 16, wherein an effective damping resistance of the programmable resistor is selectable by a digital signal.

18. The laser driver of claim 16, further comprising a damping capacitor in series with the programmable resistor.

19. The laser driver of claim 16, further comprising a controller adapted to determine and select an effective damping resistance of the programmable damping resistor.

20. A method for improving the light output response of a laser diode, comprising:
(a) adjusting an effective resistance of a programmable resistor, within a laser driver, to improve the light output response of the laser diode; and
(b) using the laser driver to drive the laser diode.

21. A method for improving the light output response of a laser diode, comprising:
(a) determining a damping resistance;
(b) adjusting a programmable resistor, within a laser driver, to provide the damping resistance; and
(c) using the laser driver to drive the laser diode.

22. The method of claim 21, wherein step (a) comprising determining the damping resistance based on inductive, capacitive and resistive characteristics of a load including a laser diode.

23. The method of claim 21, wherein step (a) is performed by a controller within the laser driver based on an input signal provided to the controller.

24. The method of claim 21, wherein step (a) comprises dynamically determining the damping resistance based on at least one of the following:
a temperature;
a voltage supply; and
a drive current.
